(19) United States
(12) Patent Application Publication
(10) Pub. No.: US 2026/0110317 A1
(43) Pub. Date: Apr. 23, 2026

(54) Push-in Clip

(71) Applicant: Illinois Tool Works Inc., Glenview, IL (US)

(72) Inventor: Victor Diez Herrera, Sabadell (ES)

(21) Appl. No.: 19/357,818

(22) Filed: Oct. 14, 2025

(30) Foreign Application Priority Data
Sep. 26, 2025 (DE) 10 2025 139 247.1
Mar. 11, 2025 (EP) 25163010.9
Oct. 21, 2024 (EP) 24207852.5

(51) Int. Cl. F16B 2/24; F16B 41/00

(52) U.S. Cl. CPC F16B 2/243; F16B 41/002

(57) ABSTRACT

A push-in clip is provided for joining two parts together. The clip includes a plunger with a head and an actuator, and a fixation body having an aperture, a collar, and one or more wings. When the plunger is pressed into the fixation body, the actuator moves the wings from a stowed position to a deployed position. In the deployed position, the wings clamp the two parts between themselves and the collar to securely hold them together.

### RELATED APPLICATIONS

The present application claims the benefit of European Patent Application No. 24207852.5, filed October 21, 2024, European Patent Application No. 25163010.9, filed March 11, 2025, and German Patent Application No. 102025139 247.1, filed September 26, 2025, each titled “Push-in Clip,” the contents of which are hereby incorporated by reference.

### BACKGROUND

The disclosure related to a push-in clip which is suitable for attaching a first part to a second part.

In manufacturing vehicles, reductions of time and simplification of construction methods contribute to ensuring a smooth production line and the speedy production of new products. It is therefore desirable to reduce the use of third party fixations (such as screws) and tooling required to attach parts together. This is because of, not only the cost of the third party fixations, but such fixations can be fiddly to use and time is required for an operative to reach for a tool for a specific fixation.

### SUMMARY

The present disclosure relates generally to a push-in clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A illustrates a push-in clip, prior to actuation and inserted into a first part.

FIG. 1B illustrates a push-in clip arranged in an intermediate position and being aligned with a second part.

FIG. 1C illustrates a push-in clip in an in-use position.

FIG. 2 illustrates a plunger of the push-in clip.

FIG. 3 illustrates an alternative push-in clip.

FIG. 4 illustrates an exploded view of an alternative push-in clip.

FIG. 5 illustrates a side view of a push-in clip.

FIG. 6A illustrates an alternative push-in clip with a plunger.

FIG. 6B illustrates an alternative push-in clip with a fixing.

FIG. 6C illustrates an alternative push-in clip with a plunger located within the fixing.

FIG. 7A illustrates an alternative push-in clip with an underside view of the push-in clip attached to a first part.

FIG. 7B illustrates an alternative push-in clip with an underside view of the push-in clip attached to a first part.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

Fasteners vary in size and shape. In some cases, fasteners can be the same shape, but will vary in size. While fasteners are most often associated with creating non-permanent joints. They are also employed in numerous other functions that may require a more permanent fixture. Therefore, the following disclosure should not be limited to fasteners used in non-permanent joints, but rather would be applicable to fastener used in any situation to couple two or more objects.

According to the disclosure there is provided a push-in clip, suitable for attaching a first part to a second part, the push in-clip comprising: a plunger comprising a head and an actuator; a fixation, the fixation comprising an aperture for receipt of the actuator, a collar, and one or more wings; wherein the one or more wings are arranged such that insertion of the plunger into the aperture urges the one or more wings from a stowed position towards a deployed position, wherein, when in the deployed position, the one or more wings are configured to trap one or more parts between the one or more wings and the collar. The present disclosure therefore avoids the problems identified above as an effective fixation can be made by hand in pushing the clip.

Suitably, by partially inserting the plunger into the aperture, the one or more wings are arrangeable in an intermediate position between the stowed position and the deployed position. The clip may be therefore temporarily placed before a final fix. This can help with alignment of parts and to ensure the clip is secure (no accidental drop out).

Preferably, the one or more wings are holdable in the intermediate position.

Suitably, the actuator comprises one or more grooves.

Preferably, the fixation comprises at least one final lock feature which is arranged to grasp the actuator once the push-in clip has been used.

Suitably, the one or wings comprise the final lock feature.

Preferably, the collar comprises one or more resilient retention members arranged to retain the plunger in an initial position, prior to use of the push-in clip. In this way the plunger cannot accidentally disassociate from the clip in transport.

Preferably, the head of the plunger is sized to operate the push-in clip by hand.

Suitably, the one or more wings may further comprise one or more interior teeth.

Preferably, the actuator comprises one or more legs, and optionally, wherein the one or more wings act as a shoe for a foot of at least one leg.

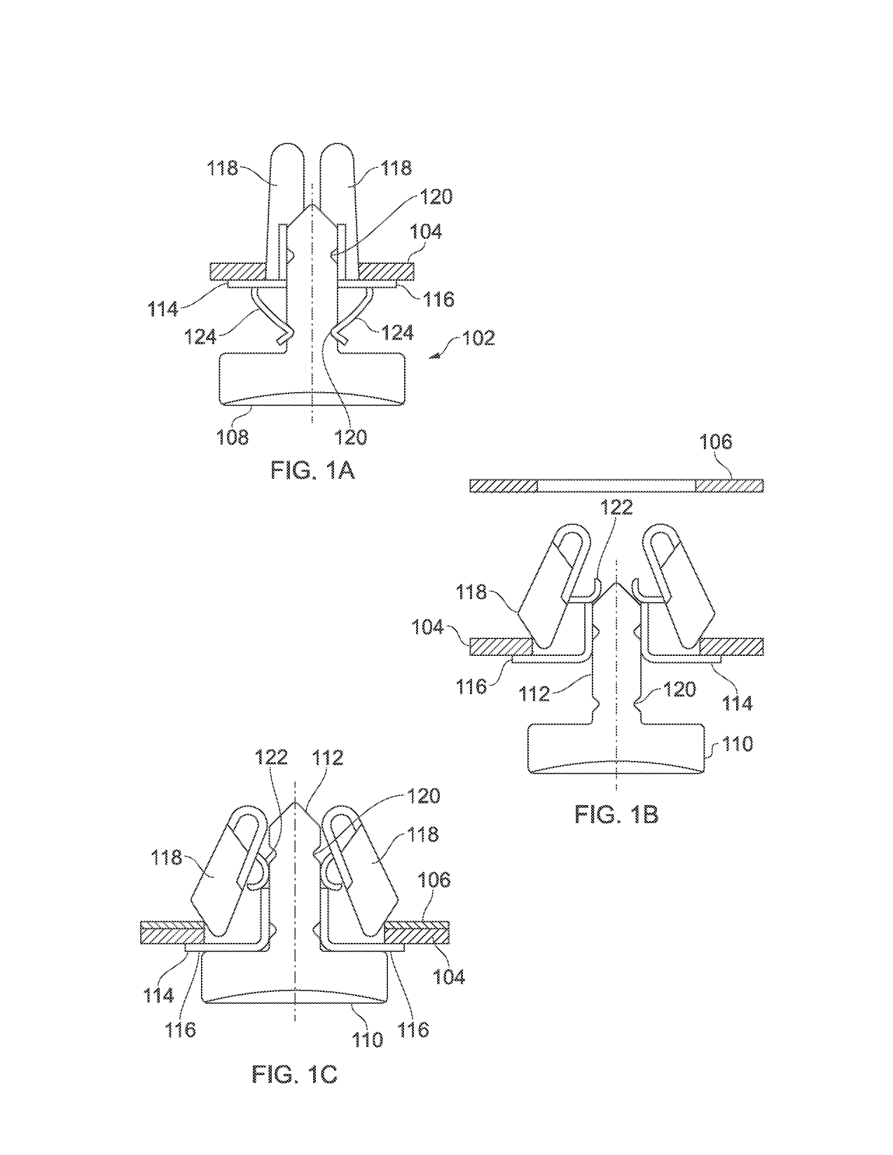

FIG. 1 shows an ergonomic clip for a screwless fixing of parts together, such as plastic or metal parts to vehicle panels which could include the glove box and/or dashboard to the underlying frame.

As shown in FIG. 1 the push-in clip 102 is suitable for attaching a first part 104 to a second part 106 through stages A) to C) in the figure. The push in-clip comprises a plunger 108 which has a head 110 and an actuator 112. The plunger 108 may be provided as a separate item to the push-in clip 102, but it is preferable that the plunger 108 is at least loosely associated with the push-in clip 102 to ensure each push-in clip 102 has a plunger 108 ready for an operator to use, without additional searching or identification. The collar may therefore comprise one or more resilient retention members 124 arranged to retain the plunger in an initial position, prior to use of the push-in clip.

The plunger 108 may be formed of any suitable material, but is typically a metal. The head 110 is sized to allow an operative to push the actuator 112 to operate the fixation 114 without additional tooling. The head 110 is therefore ergonimic. It will be appreciated that the size of the head 110 will therefore vary depending on intended load to be borne by the push-in clip 102 and the force required to drive the head 110 into the fixation 114 by hand comfortably.

The push-in clip 102 also has a fixation 114. The fixation comprises an aperture for receipt of the actuator, so the actuator 112 of the plunger 108 can operate the fixation 114. A collar 116 is provided, the aperture is located in the collar. The collar serves to provide a large surface area for resting on a surface of a first part, to resist pull through of the push-in clip 102 through the first part. The collar also ensures that the push-in clip 102 is agnostic to the dimensions of the aperture in the first part for receiving the push-in clip 102, manufacturing tolerances may therefore be relaxed.

The fixation 114 also comprises one or more wings 118. The wings are arranged such that insertion of the plunger into the aperture urges the one or more wings from a stowed position towards a deployed position. The wings 118 may therefore be arranged to interfere with the insertion of the plunger 108, so at least part of the wings 118 should lie in the intended path of the plunger 108, so the plunger 108 can move the wings 118. When in the deployed position, the one or more wings are configured to trap one or more parts 106, 104 between the one or more wings and the collar. The wings 118 may comprise a trap or well such that the wings 118 in the stowed position may pass through a first part and a second part, but once in the deployed position, the parts are trapped by the wings 118 and sandwiched between the wings 118 and the collar 116.

The wings 118 may further comprise one or more chamfered surfaces, arranged to interfere with a vertex of an aperture of the second part 106. In this way, the wings 118 are agnostic to the thickness of the second part 106 as the ramped surface may be contacted at any point along its length by the vertex to provide a secure and play-free grip by the fixation 114 of the second part 106.

The fixation 114 may be designed such that by partially inserting the plunger into the aperture, the one or more wings are arranged in an intermediate position (a pre-locking position) between the stowed position and the deployed position. In this way the push-in clip 102 may be located in a first part 104, and loosely held there. This can be useful when the push-in clip 102 must be inserted up-side-down into the first part 104 and prevents the push-in clip 102 falling off of the first part 104 while the first part 104 is aligned with the second part 106. As such the one or more wings may be held in the intermediate position by the head 110.

This can be achieved by a first set of grooves 120 located on the plunger 108, which escapably trap a final lock feature 122. The grooves 120 may be comparatively shallow or ramped to allow escape of the final lock feature 122 on further insertion of the plunger 108 into the fixation 114.

The actuator may comprise one or more sets of grooves 120, where an intermediate position is required, the actuator 112 preferably comprises a first set of grooves 120 and a second set of grooves 120 to provide a final, and inescapable trap for the final lock feature 122 of the fixation 114.

The final lock feature 122 may be positioned on the one or more wings . The final lock feature 122 which is arranged to grasp the actuator once the push-in clip has been used. The final lock feature 122 may take the form of a resilient tongue that falls within the grooves 120 of the plunger 108 and lock in that position. Alternatively, the final lock feature 122 may be designed to only escape from the grooves 120 on intentional removal by an operative.

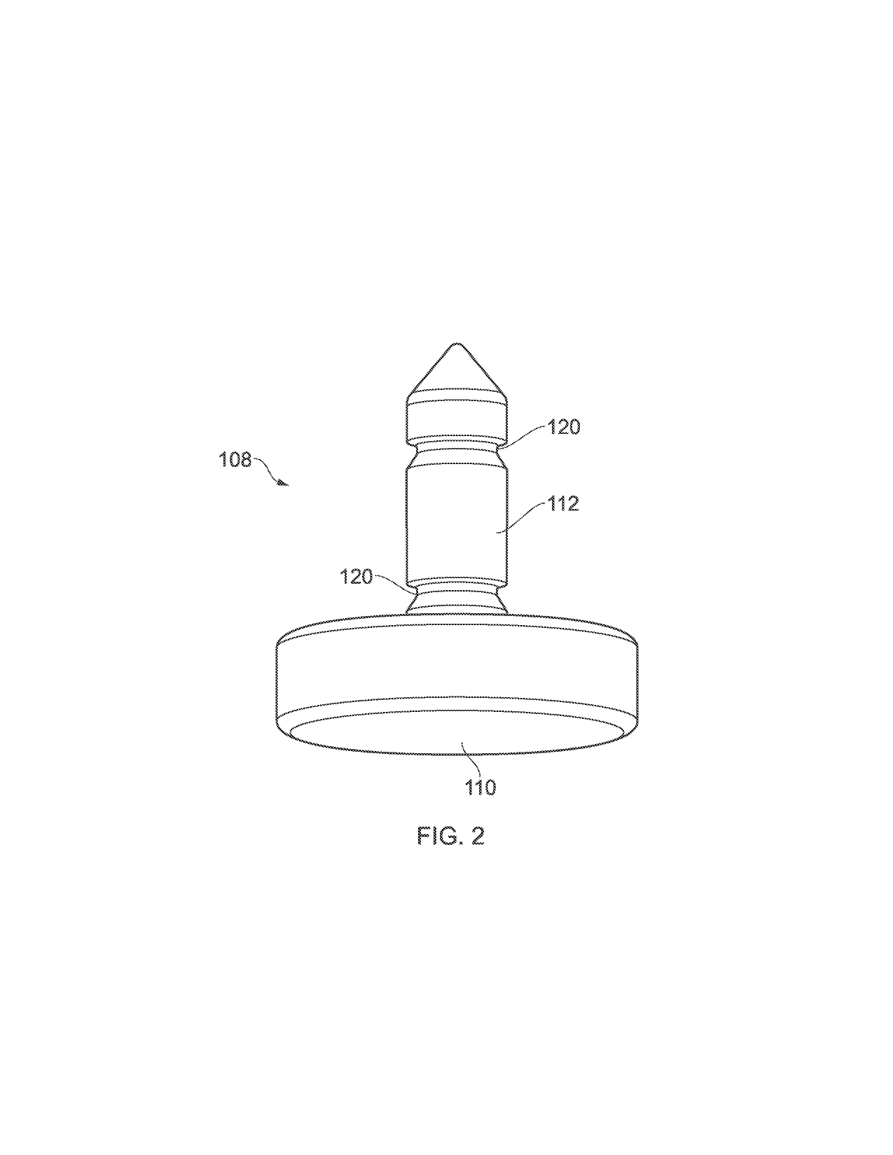

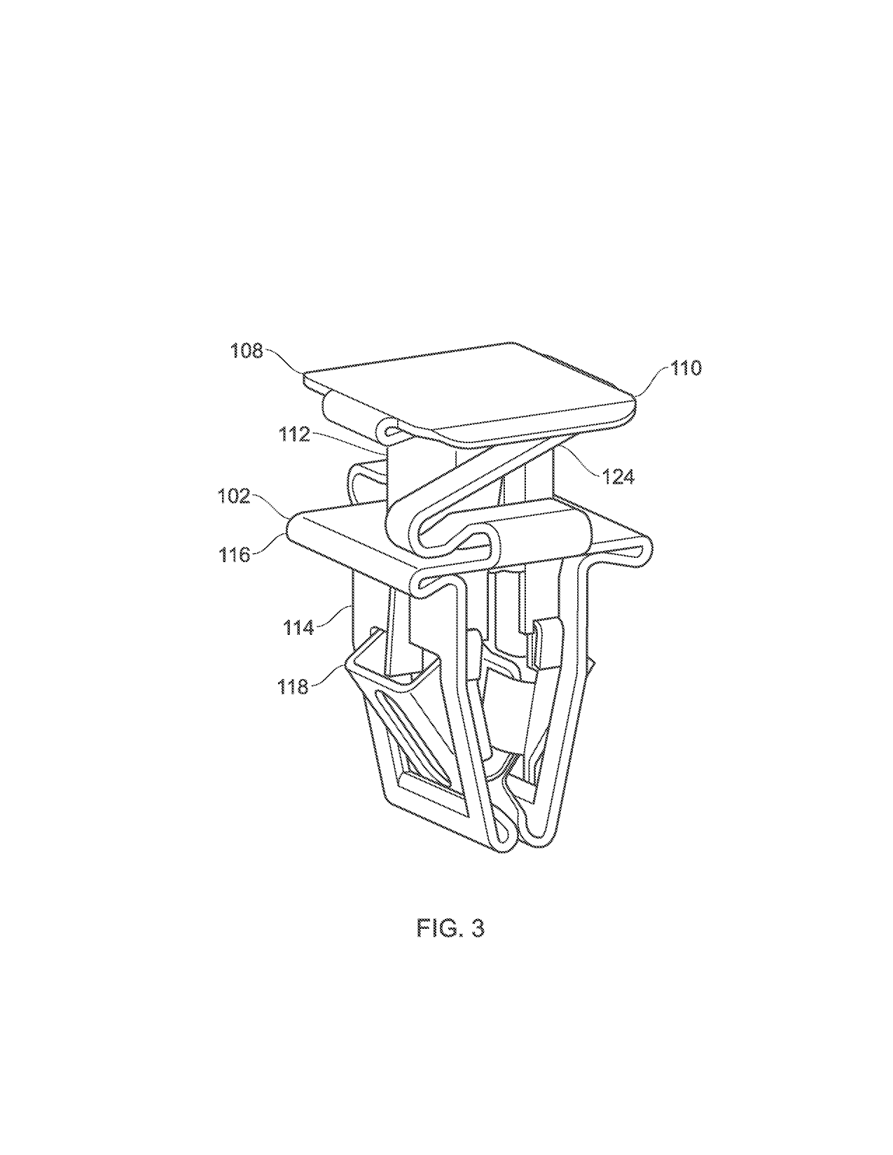

The plunger 108 of FIG. 1 is shown absent the push-in clip 102 in FIG. 2. The head of the plunger is sized to operate the push-in clip by hand, as discussed above. The plunger 108 also comprises two sets of grooves 120 which provide the trap for the intermediate position and the trap for the final lock feature. It will be apparent that more or less grooves may be provided to give more or less trapping positions.

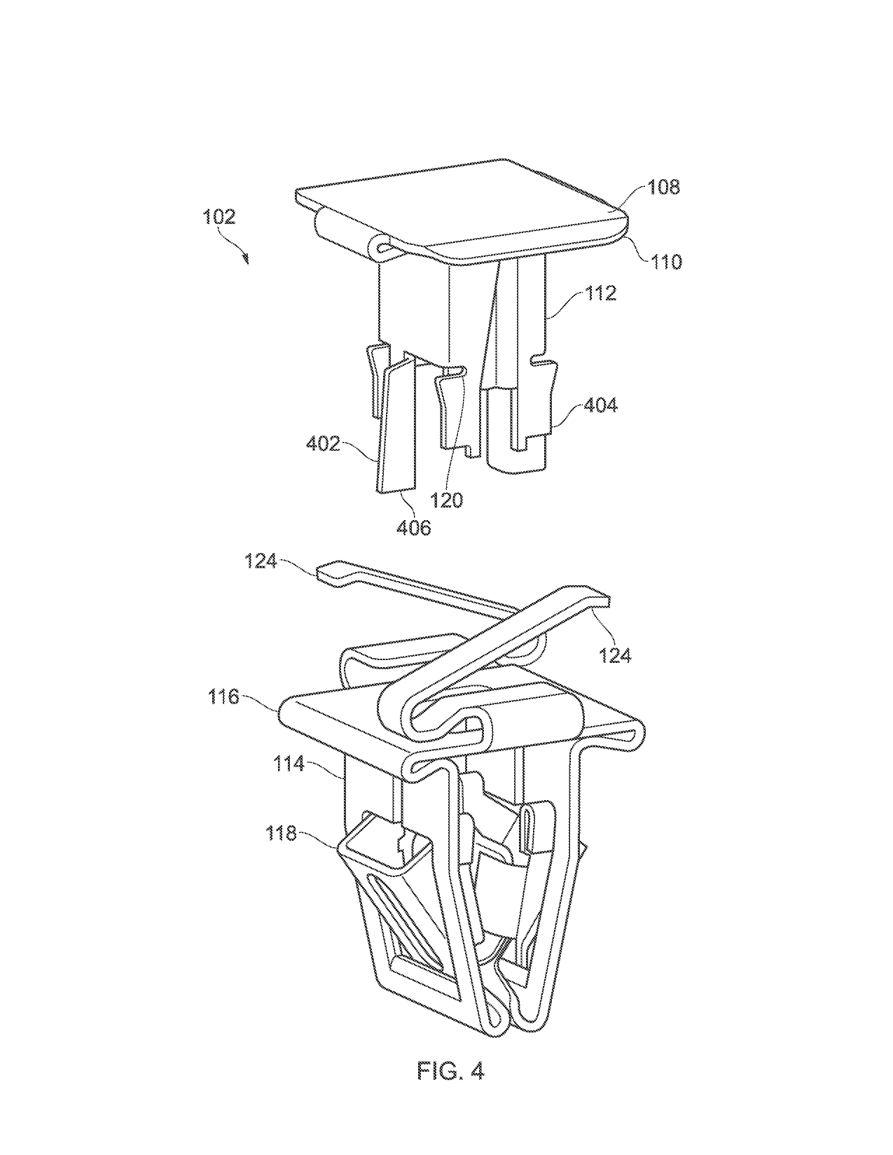

FIGS. 3 to 5 shows an alternative push-in clip 102 which shares many similar features to the push-in clip 102 of FIGS. 1 and 2. Like features are provided with like reference numerals to avoid unnecessary repetition.

The push-in clip 102 of FIG. 3 differs in being formed via stamping or folding from a flat base material, such as a metal sheet.

The push-in clip 102 has a plunger 108, better shown in FIG. 4. The plunger 108 possesses a head 110 to allow an operative to urge the plunger 108 towards the fixation 114, preferably by hand and/or without the use of a tool. The plunger 108 further comprises an actuator 112 to move the fixation 114 between a pre-use and an in-use position. That is, a position where the wings 118 are in an initial position (pre-use) and where the wings 118 are in a deployed position.

To achieve this, the actuator 112 comprises one or more legs 402. The word “legs”, where plural legs 402 are present, does not infer any shape or similarity between the legs 402 (i.e. Each leg may have the same, similar, or different shape and dimensions to any other leg). A leg may have an L-shaped structure to provide additional rigidity or any other suitable structure ("C", “I”, or “N” shaped for example) provided that the structure selected provides resistance to unintentional deformation.

Each of the plurality of legs may have a specific function. A first leg may actuate one or more of the wings 118 via a ramped surface arranged to interfere with a contact surface of the relevant wing when the plunger 108 is urged towards the fixation 114. A second leg may dictate the path of travel of the plunger 108 within the fixation 114. The second leg may also comprise one or more features such as one or more grooves 120 arranged to interact with at least one final lock feature 122 which is arranged to grasp the actuator once the push-in clip has been used.

Preferably, the plunger 108 is trapped within the fixation 114 during manufacture, for example by folding the collar 116 over a knee of one of the legs 402 to prevent the plunger 108 from being lost from the fixation 114. This ensured the push-in clip 102 is provided ready to use. Any other suitable entrapment means may be used, such as resiliently biasing the legs 404 so that the plunger 108 has a snap-fit within the fixation 114.

The collar 116 may comprise one or more resilient retention members 124 which are arranged to retain the plunger in an initial position, prior to use of the push-in clip, preventing unintentional movement of the plunger 108 into the final lock feature 122 which would prevent use of the push-in clip 102.

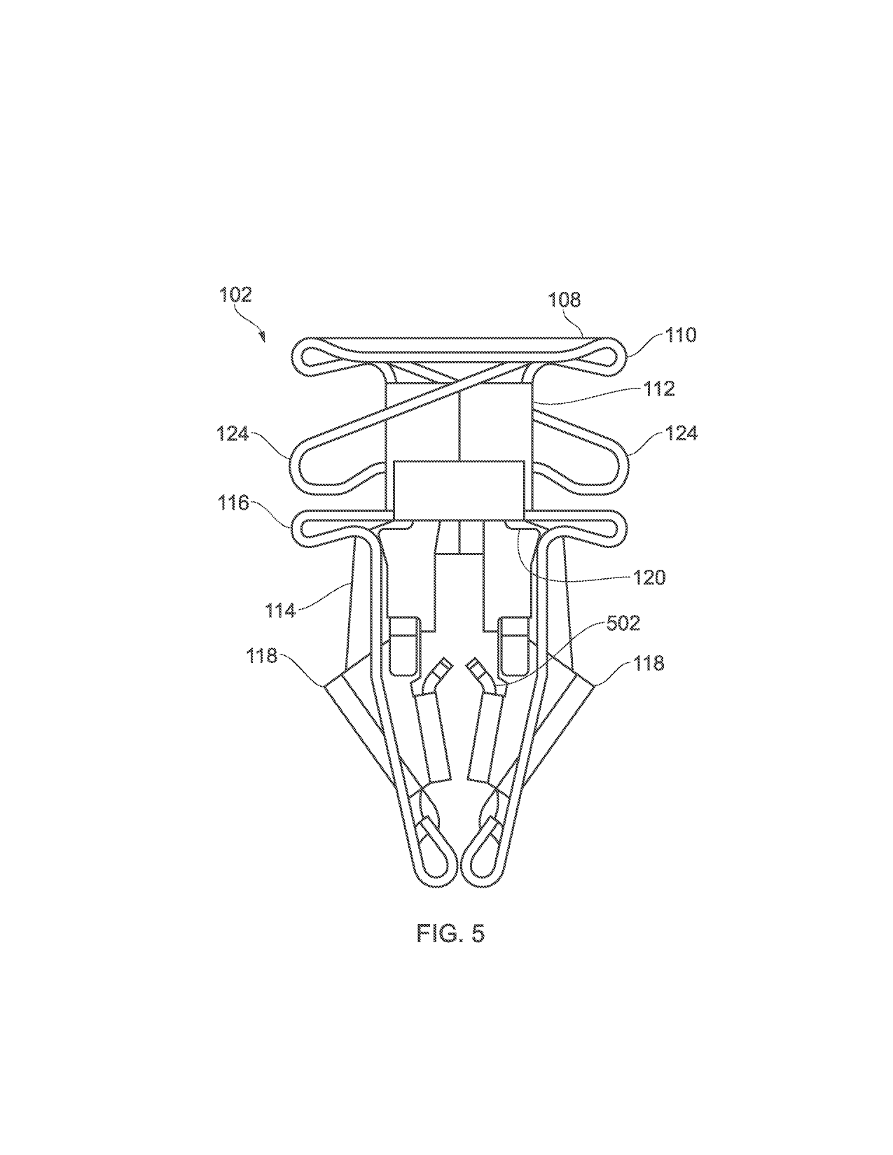

FIG. 5 shows the push-in clip 102 in a pre-use position with the wings 118 in a stowed position. When the push-in clip 102 is intended to be used, an operative inserted the push-in clip 102 into suitable apertures of a first part 104 and a second part 106. When in place the collar 116 is arranged on a first side of the first part and the wings 118 are arranged on a second side of the second part 106, which is remote from the first side of the first part 104. The parts are therefore sandwiched between the wings 118 and the collar 116.

Suitably, the push-in clip 102 has a non-circular cross section which corresponds to the shape of either or both of the apertures of the first part 104 and second part 106 so that rotation of the any of the parts is resisted. In the push-in clip 102 shown the fixation 114 has a substantially quadrilateral cross section, but it will be apparent that any other non-circular shape may provide the function of rotation resistance.

Once the push-in clip 102 is in position, the operative may then begin to urge the plunger 108 towards the fixation 114. The legs 402 travel within the fixation 114 and interact with the features of the fixation 114. A first leg contacts a wings 118 and urges the wings towards the deployed position. A second leg is arranged to guide the travel of the plunger 108 within the fixation 114 by running along a track to dictate the path and extent of travel. The leg may be provided with one or more grooves 120 arranged to bind on a wall of the fixation 114, the wall therefore provides a final lock feature to prevent further travel of the fixation 114 and/or removal of the plunger 108 from the fixation 114. In the alternative, a leg may be provided with a shoulder to achieve same effect. In the images, the wall is that above the aperture which the wings 118 protrude from the fixation 114. However, any suitable wall may be used or a specific internal feature may provide a final lock surface.

The wings 118 may further comprise one or more interior teeth 502 which, as the wings 118 move from the stowed position to the deployed position, are arranged to contact a leg 402, thereby limiting travel of the wings 118 beyond the deployed position.

The wings 118 may comprise a hollow interior, or otherwise be substantially bucket shaped, such that the leg which urges the wings 118 towards the deployed position is trapped or otherwise housed within the wings 118. In other words, the wings 118 may act as a shoe for the foot 406 of the leg.

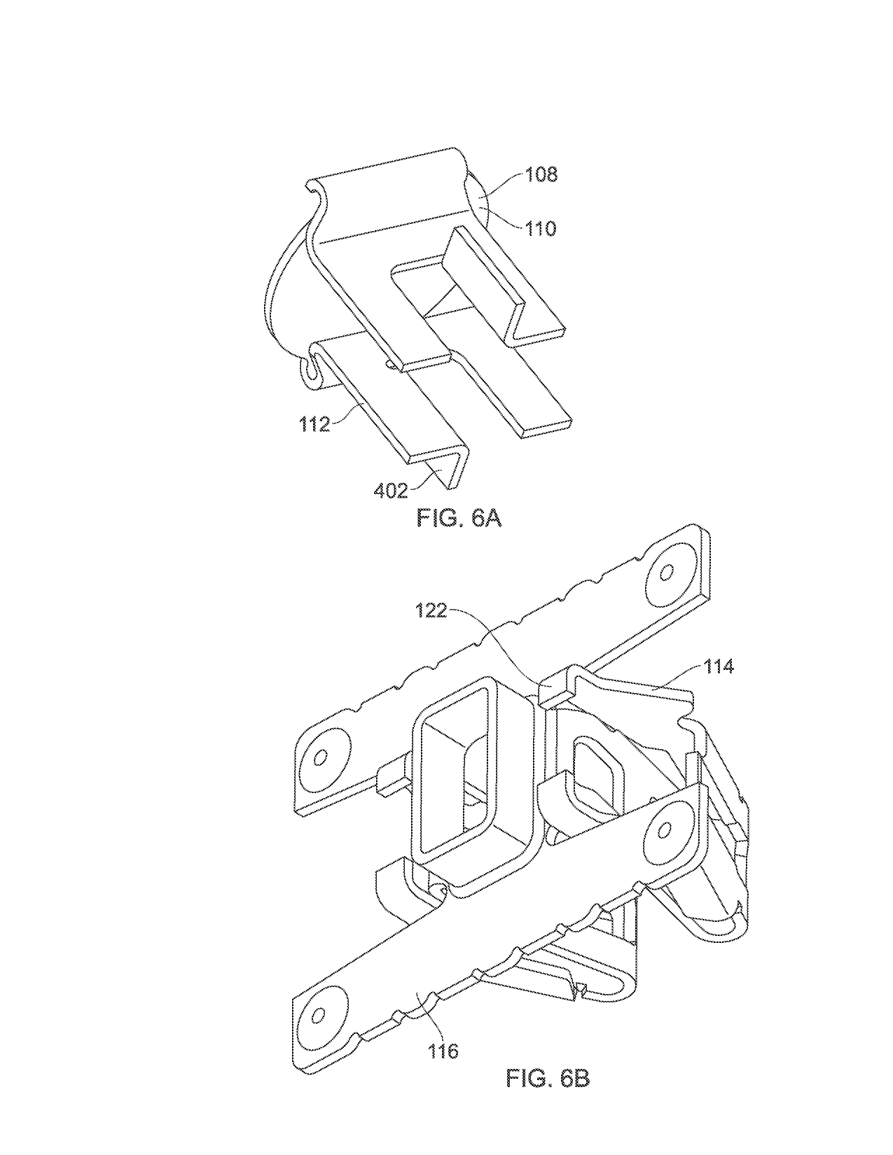

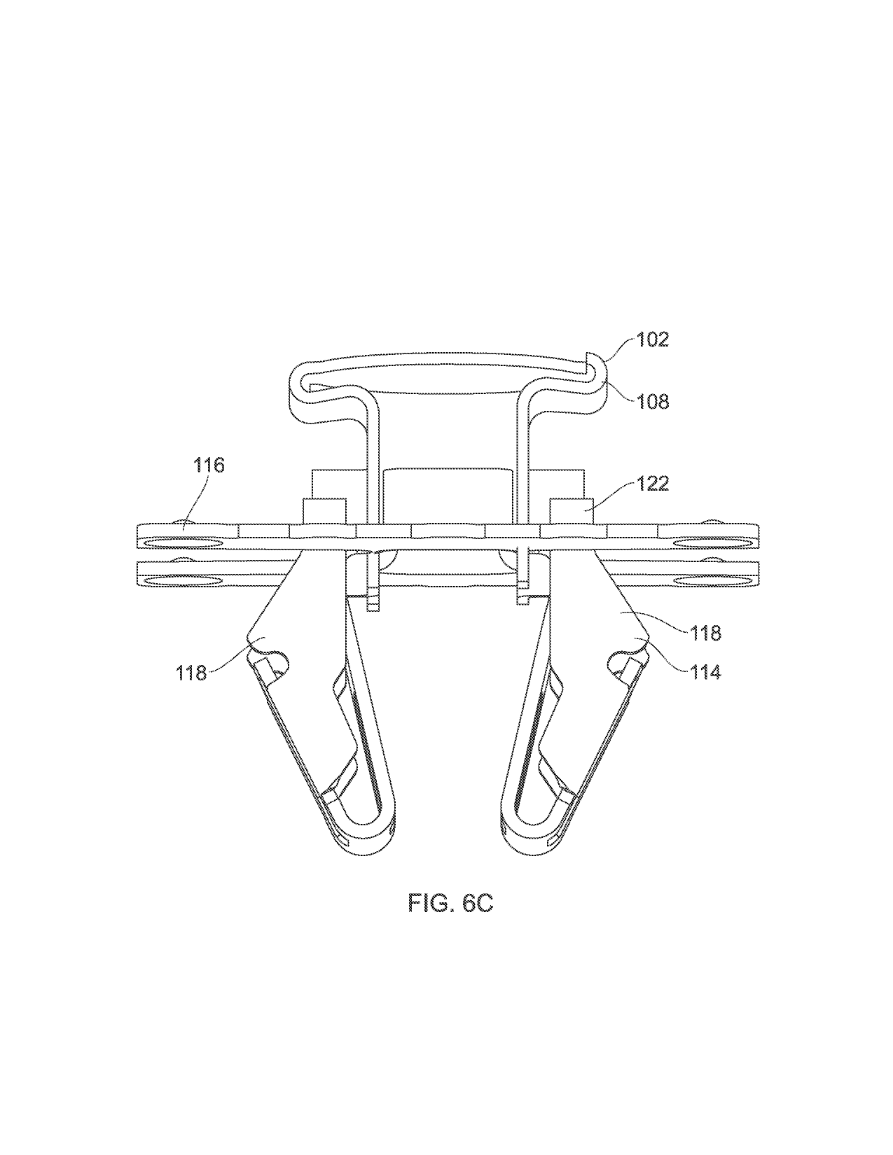

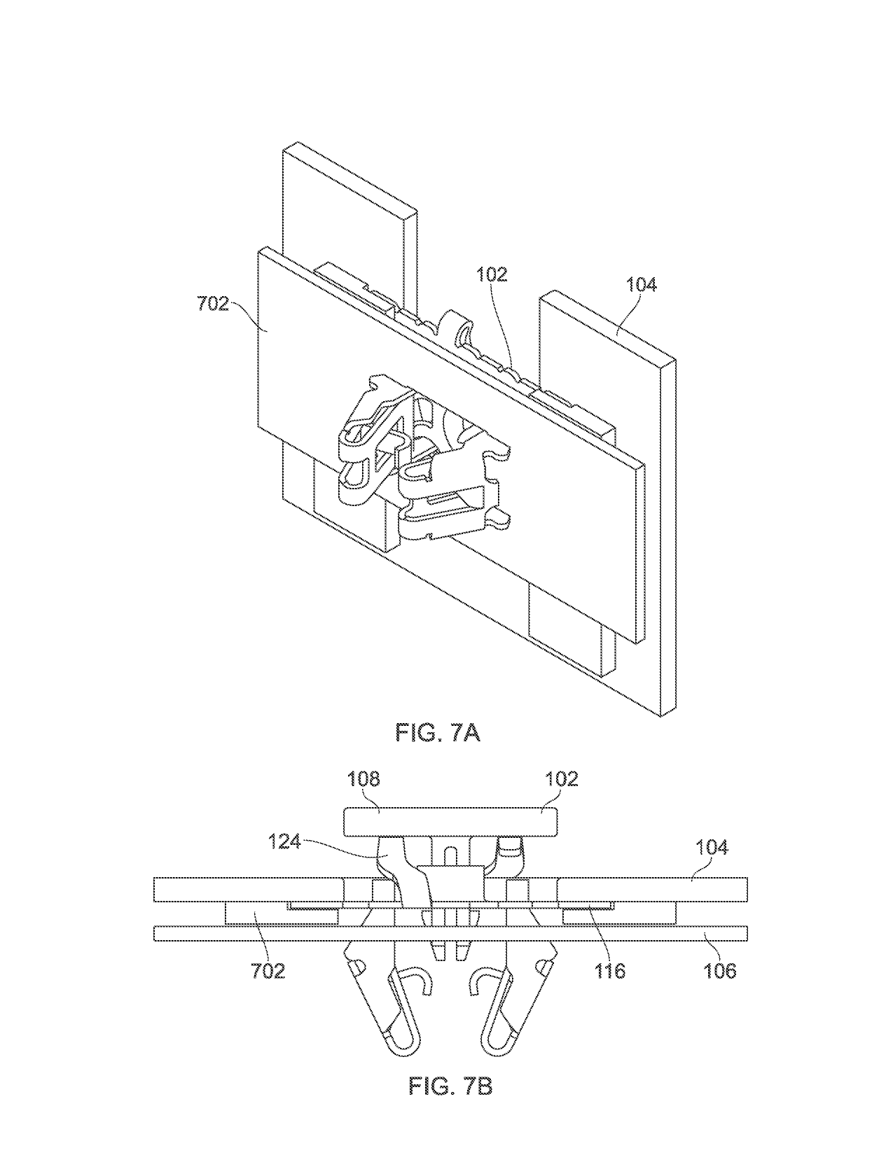

FIGS. 6 and 7 show an alternative push-in clip 102 which shares many similar features to the push-in clip 102 of FIGS. 1 to 5. Like features are provided with like reference numerals to avoid unnecessary repetition. The push-in clip of FIGS. 6 and 7 principally differs in being provided with a collar 116 that is intended to incorporated with the first part 104 on production of the first part 104. This is so that the push-in clip 102 is provided ready to use and does not require fitment by an operative on the production line. In order to ensure a secure attachment of the push-in clip 102 with the first part 104, the first part 104 is provided is a dog house 702, in which the collar 116 of the first part 104 can be located and/or embedded. The dog house 702 may provide a baggy fit, at least in one direction, to allow a permitted play between the collar 116 and the first part 104 to allow for misalignment of the first part 104 and the second part 106. Alternativley, the dog house 702 may be provided with a tight fit to the push-in clip 102, e.g. By injection molding or extruding the first part 104 about the collar 116. The collar 116 may be provided with one or more apertures, cut outs, or suitable topological features to provided a keyed surface to improve grip and retention of the collar 116 in the dog house 702.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process so disclosed.

What is claimed is:

1. A push-in clip (102), suitable for attaching a first part (104) to a second part (106), the push in-clip comprising:
a plunger (108) comprising a head (110) and an actuator (112);
a fixation (114), the fixation comprising an aperture for receipt of the actuator, a collar (116), and one or more wings (118);
wherein the one or more wings are arranged such that insertion of the plunger into the aperture urges the one or more wings from a stowed position towards a deployed position, wherein, when in the deployed position, the one or more wings are configured to trap one or more parts (106, 104) between the one or more wings and the collar.

2. The push-in clip of claim 1, wherein, by partially inserting the plunger into the aperture, the one or more wings are arrangeable in an intermediate position between the stowed position and the deployed position.

3. The push-in clip of claim 2, wherein the one or more wings are holdable in the intermediate position.

4. The push-in clip of claim 1, wherein the actuator comprises one or more grooves (120).

5. The push-in clip of claim 1, wherein the fixation, comprises at least one final lock feature (122) which is arranged to grasp the actuator once the push-in clip has been used, and wherein the one or wings comprise the final lock feature (122).

6. The push-in clip of claim 1, wherein the collar comprises one or more resilient retention members (124) arranged to retain the plunger in an initial position, prior to use of the push-in clip.

7. The push-in clip of claim 1, wherein the head of the plunger is sized to operate the push-in clip by hand.

8. The push-in clip of claim 1, wherein the one or more wings (118) may further comprise one or more interior teeth (502).

9. The push-in clip of claim 1, wherein the actuator (112) comprises one or more legs (402), and wherein the one or more wings (118) act as a shoe for a foot (406) of at least one leg.

10. A first part (104), intended to be connected with second part (106), wherein the first part is provided with a push-in clip (102) as claimed in claim 1 pre-installed.

11. A push-in clip for attaching a first part to a second part, the push-in clip comprising:
a plunger including a head and an actuator; and
a fixation including a collar, an aperture sized to receive the actuator, and one or more wings,
wherein insertion of the plunger into the aperture urges the one or more wings from a stowed position toward a deployed position,
and wherein, in the deployed position, the one or more wings are configured to trap the first and second parts between the one or more wings and the collar.

12. The push-in clip of claim 11, wherein partial insertion of the plunger into the aperture positions the one or more wings in an intermediate position between the stowed position and the deployed position.

13. The push-in clip of claim 12, wherein the one or more wings are configured to be retained in the intermediate position.

14. The push-in clip of claim 11, wherein the actuator includes one or more grooves.

15. The push-in clip of claim 11, wherein the fixation includes at least one final lock feature arranged to grasp the actuator after the push-in clip is installed, and wherein the one or more wings include the final lock feature.

16. The push-in clip of claim 11, wherein the collar includes one or more resilient retention members configured to retain the plunger in an initial position prior to installation.

17. The push-in clip of claim 11, wherein the head of the plunger is sized and shaped for manual operation.

18. The push-in clip of claim 11, wherein the one or more wings include one or more interior teeth.

19. The push-in clip of claim 11, wherein the actuator includes one or more legs, each leg having a foot, and wherein the one or more wings act as a shoe for the foot of at least one leg.
